(19) United States
(12) Patent Application Publication
(10) Pub. No.: US 2011/0150143 A1
(43) Pub. Date: Jun. 23, 2011

(54) SOFT-DECISION DEMAPPING METHOD FOR DIGITAL SIGNAL

(75) Inventors: Jae Hee Han, Daejeon (KR); Pan Soo Kim, Daejeon (KR); Dae Ig Chang, Daejeon (KR); Jang Woong Park, Suwon-si (KR); Myung Hoon Sunwoo, Suwon-si (KR)

(73) Assignee: ELECTRONICS AND TELECOMMUNICATIONS RESEARCH INSTITUTE, Daejeon-city (KR)

(21) Appl. No.: 12/915,449

(22) Filed: Oct. 29, 2010

(30) Foreign Application Priority Data
Dec. 18, 2009 (KR) 10-2009-0127356
Apr. 1, 2010 (KR) 10-2010-0030053

(51) Int. Cl. H04L 27/22

(52) U.S. Cl. 375/329

(57) ABSTRACT

Disclosed is a demapping method of a soft-decision of an efficient soft determining scheme which is applicable to a DVB-2 satellite communication system. The soft-decision demapping method for a digital signal received through a transmission channel in a communication system using a phase shift keying (PSK) scheme includes: selecting reference symbols in an area having a higher probability than a predetermined probability that the received signal will be positioned among all reference symbols on a constellation diagram using a most significant bit (MSB) value of the received signal; and acquiring a maximum value of a log likelihood ratio (LLR) for the selected reference symbols.

### CROSS-REFERENCE TO RELATED APPLICATIONS

This application claims priority under 35 U.S.C. §119 to Korean Patent Application No. 10-2009-0127356, filed on Dec. 18, 2009, and 10-2010-0030053, filed on Apr. 1, 2010, in the Korean Intellectual Property Office, the disclosure of which is incorporated herein by reference in its entirety.

### BACKGROUND OF THE INVENTION

1. Field of the Invention

The present invention relates to a soft-decision type demapping method for a digital signal applicable to a digital video broadcasting (DVB) satellite communication system.

2. Description of the Related Art

In a related art of wireless communication system, a log likelihood ratio (LLR) method has been widely studied in a soft-decision demapping method.

In this related art of system, a sequence of complex modulation symbols having white noise and a frequency error fₑ and a phase θ that are not compensated may be expressed as shown in Equation 1.

rₖ=aₖe^{j(2πkf}^{ₑ}^{T+θ)}+nₖ [Equation 1]

Where aₖ represents a modulation symbol, T represents a symbol duration, and nₖ represents a complex sequence of white noise having dispersion of σ².

A soft-decision demapping algorithm used in a user terminal of a receiver of the wireless communication system is configured to generally transfer a soft-decision value for each bit of a received signal to a forward error correction (FEC) for error detection and error correction.

As shown in FIG. 1, in the case of an 8-phase shift keying (PSK) modulation scheme, an apparatus for performing the related art of LLR-scheme soft-decision demapping algorithm generally acquires probabilities for three bits b₀, b₁, and b₂ expressing symbols as shown in Equations 2 and 3. Equation 2 expresses a probability density function of a symbol received through a white noise channel.

$${P}_{i} = \frac{1}{\sqrt{2 {πσ}^{2}}} {e}^{\frac{{\vert r - {s}_{i} \vert}^{2}}{2 {σ}^{2}}} , \\ i = 0 , … , 7 \qquad [ Equation 2 ]$$

Herein, Sᵢ represents a constellation point on a constellation diagram and σ² represents a dispersion level of white noise.

A value of the soft-decision type using the log likelihood ratio may be expressed as Equation 3.

$$LLR ( {b}_{2} ) = log \frac{{P}_{0} + {P}_{1} + {P}_{2} + {P}_{3}}{{P}_{4} + {P}_{5} + {P}_{6} + {P}_{7}} \\ LLR ( {b}_{1} ) = log \frac{{P}_{0} + {P}_{1} + {P}_{4} + {P}_{5}}{{P}_{2} + {P}_{3} + {P}_{6} + {P}_{7}} \\ LLR ( {b}_{0} ) = log \frac{{P}_{0} + {P}_{2} + {P}_{4} + {P}_{6}}{{P}_{1} + {P}_{3} + {P}_{5} + {P}_{7}} \qquad [ Equation 3 ]$$

Referring to Equations 2 and 3, a log likelihood ratio scheme requires a squaring operation for calculating distances between symbols and constellation points, and finally requires exponential and logarithmic operations in order to acquire the log likelihood ratio. Since the exponential and logarithmic operations largely increase hardware complexity, they are not suitable for hardware implementation.

Meanwhile, a maximum value scheme (MAX scheme) is proposed in order to reduce the complexity of the related art of log likelihood ratio scheme. The MAX scheme can reduce the exponential and logarithmic operations of Equation 3 by using a property of an exponential function as shown in Equation 4.

LLR(b₂)={ max(P₀,P₁,P₂,P₃)−max(P₄,P₅,P₆,P₇)}

LLR(b₁)={ max(P₀,P₁,P₄,P₅)−max(P₂,P₃,P₆,P₇)}

LLR(b₀)={ max(P₀,P₂,P₄,P₆)−max(P₁,P₃,P₅,P₇)} [Equation 4]

Where Pi (here, i may be 0 or natural numbers) becomes an exponential part in the probability density function of Equation 3 as shown in Equation 5.

$${P}_{i} = \frac{- {\vert r - {s}_{i} \vert}^{2}}{2 {σ}^{2}} , \\ i = 0 , … , 7 \qquad [ Equation 5 ]$$

Meanwhile, a Euclidean scheme is an operation reducing multiplication of channel estimation values shown in Equations 3 and 5 which is expressed as Equation 6.

dᵢ=\sqrt{(r−sᵢ)²}, i=0, . . . , 7

LLR(b₂)={ min(d₀,d₁,d₂,d₃)−min(d₄,d₅,d₆,d₇)}

LLR(b₁)={ min(d₀,d₁,d₄,d₅)−min(d₂,d₃,d₆,d₇)}

LLR(b₀)={ min(d₀,d₂,d₄,d₆)−min(d₁,d₃,d₅,d₇)} [Equation 6]

However, since the Euclidean scheme requires the square root and the squaring operation, the Euclidean scheme operation has hardware complexity larger than the MAX scheme operation.

### SUMMARY OF THE INVENTION

In order to solve the above-mentioned problems, according to exemplary an embodiment of the present invention, there is provided a soft-decision demapping method for a digital signal capable of achieving stable performance and efficiently using hardware resources even in a channel environment of a very low signal-to-noise ratio (SNR).

According to an aspect of the present invention, there is provided a soft-decision demapping method for a digital signal received through a transmission channel in a communication system using a phase shift keying (PSK) scheme that includes: selecting reference symbols in an area having a higher probability than a predetermined probability that the received signal will be positioned among all reference symbols on a constellation diagram using a most significant bit (MSB) value of the received signal; and acquiring a maximum value of a log likelihood ratio (LLR) for the selected reference symbols.

In the embodiment, the soft-decision demapping method further includes: shifting the reference symbols by a predetermined phase so that the reference symbols are positioned between an in-phase axis and a quad-phase axis when at least one reference symbol is positioned on the in-phase axis or the quad-phase axis of the constellation diagram.

### BRIEF DESCRIPTION OF THE DRAWINGS

FIG. 1 is showing a related art of 8-PSK constellation diagram;

FIG. 2A is showing an exemplary quadrature phase shift keying (QPSK) constellation diagram for describing a soft-decision type demapping algorithm;

FIG. 2B is showing an exemplary QPSK constellation diagram according to a comparative example;

FIG. 3 is showing an exemplary 8-PSK constellation diagram for describing a soft-decision type demapping algorithm;

FIG. 4A is showing an exemplary 16-amplitude and phase shift keying (APSK) constellation diagram for describing a soft-decision type demapping algorithm;

FIG. 4B is showing an outer ring of 16-APSK constellation diagram of FIG. 4A;

FIG. 4C is showing an inner ring of 16-APSK constellation diagram of FIG. 4A;

FIG. 5 is showing a 32-APSK constellation diagram for describing a soft-decision type demapping algorithm;

FIGS. 6A to 6D are an exemplary diagram comparing bit error ratio (BER) operation performance with a related art scheme; and

FIG. 7 is an exemplary flowchart of a soft-decision demapping method.

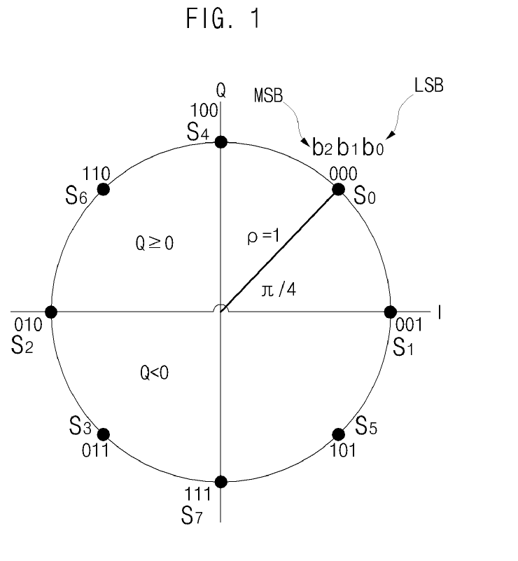

### DETAILED DESCRIPTION OF THE PREFERRED EMBODIMENTS

Hereinafter, exemplary embodiments of the present invention will be described in detail with reference to the accompanying drawings and contents to be described below. However, the present invention is not limited to embodiments described herein and may be implemented in other forms. The embodiments introduced herein are provided to fully understand the disclosed contents and fully transfer the spirit of the present invention to those skilled in the art. Like elements refer to like reference numerals throughout the specification. Meanwhile, terms used in the specification are used to explain the embodiments and not to limit the present invention. In the specification, a singular type may also be used as a plural type unless stated specifically. “Comprises” and/or “comprising” used the specification mentioned constituent members, steps, operations and/or elements do not exclude the existence or addition of one or more other components, steps, operations and/or elements.

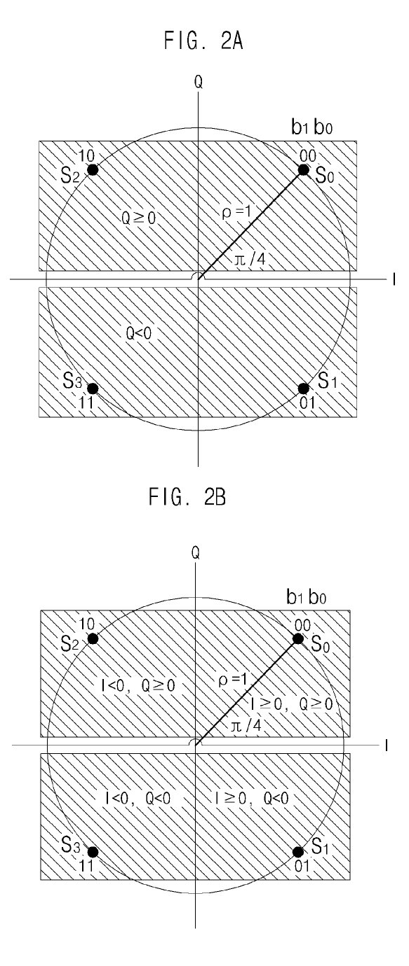

FIG. 2A is showing an exemplary QPSK constellation diagram. FIG. 2B is showing a QPSK constellation diagram according to a comparative example.

Referring to FIG. 2A, the soft-decision type demapping algorithm according to the embodiment of the present invention uses only two reference symbols of S₀ and S₂ in the case of the quadrature phase shift keying (QPSK) constellation diagram.

More specifically, as shown in FIG. 2B, the QPSK constellation diagram according to the comparative example is partitioned into four sections by using most significant sign bits of an in-phase and a quad-phase. Accordingly, to calculate an LLR(b₁) value, that is, a soft-decision (b₁) value, through a MAX scheme in the QPSK constellation diagram according to the comparative example, the reference symbols of S₀, S₁, S₂, and S₃ should be used.

However, the QPSK constellation diagram according to the embodiment of the present invention is partitioned into two sections using only the most significant sign bit of the quad-phase. When the most significant bit (MSB) is 1, the received symbol is closer to S₂ than to S₃ and when the MSB is 0, the received symbol is closer to S₀ than to S₁. So, the algorithm of the embodiment acquires the maximum value (MAX) by calculating only a symbol having a high probability that it will be positioned in the constellation diagram using the MSB value. In other words, the algorithm of the embodiment acquires the maximum value by calculating only a reference symbol in a signal discrimination area having a relatively high probability that a received signal will be positioned therein on the constellation diagram.

For example, LLR(b₁) of Equation 4 is expressed in accordance with the algorithm of the embodiment as shown in Equation 7.

$$\begin{matrix}LLR ( {b}_{1} ) = max ( {P}_{0} , {P}_{1} ) - max ( {P}_{2} , {P}_{3} ) \\ = \{ \begin{matrix}{P}_{0} - {P}_{2} , & Q \geq 0 \\ {P}_{1} - {P}_{3} , & Q < 0\end{matrix}\end{matrix} \qquad [ Equation 7 ]$$

When Equation 5 is applied to Equation 7, Equation 8 can be acquired.

$$\begin{matrix}LLR ( {b}_{1} ) = \{ \begin{matrix}- 1 / {σ}^{2} \{ {I}_{r} ( {I}_{{s}_{2}} - {I}_{{s}_{0}} ) + {Q}_{r} ( {Q}_{{s}_{2}} - {Q}_{{s}_{0}} ) \} , & Q \geq 0 \\ - 1 / {σ}^{2} \{ {I}_{r} ( {I}_{{s}_{3}} - {I}_{{s}_{1}} ) + {Q}_{r} ( {Q}_{{s}_{3}} - {Q}_{{s}_{1}} ) \} , & Q < 0\end{matrix} \\ = \{ \begin{matrix}- 1 / {σ}^{2} \{ {I}_{r} ( cos ( 3 π / 4 ) - cos ( π / 4 ) ) + {Q}_{r} ( sin ( 3 π / 4 ) - sin ( π / 4 ) ) \} , & Q \geq 0 \\ - 1 / {σ}^{2} \{ {I}_{r} ( cos ( - 3 π / 4 ) - cos ( - π / 4 ) ) + {Q}_{r} ( sin ( - 3 π / 4 ) - sin ( - π / 4 ) ) \} , & Q < 0\end{matrix} \\ = \{ \begin{matrix}2 {I}_{r} cos ( π / 4 ) / {σ}^{2} , & Q \geq 0 \\ 2 {I}_{r} cos ( π / 4 ) / {σ}^{2} , & Q < 0\end{matrix} \\ = \sqrt{2} {I}_{r} / {σ}^{2}\end{matrix} \qquad [ Equation 8 ]$$

Where I_{y} represents an in-phase value of the received symbol, more specifically, an in-phase signal component of a y-th reference symbol and Q_{y} represents a quad-phase value of the received symbol, more specifically, a quad-phase signal component of the y-th reference symbol.

Similar to Equation 8, LLR(b₀) can be expressed as shown in Equation 9.

$$\begin{matrix}LLR ( {b}_{0} ) = \{ \begin{matrix}- 1 / {σ}^{2} \{ {I}_{r} ( {I}_{{s}_{1}} - {I}_{{s}_{0}} ) - {Q}_{r} ( {Q}_{{s}_{1}} - {Q}_{{s}_{0}} ) \} , & Q \geq 0 \\ - 1 / {σ}^{2} \{ {I}_{r} ( {I}_{{s}_{3}} - {I}_{{s}_{2}} ) - {Q}_{r} ( {Q}_{{s}_{3}} - {Q}_{{s}_{2}} ) \} , & Q < 0\end{matrix} \\ = \{ \begin{matrix}2 {Q}_{r} sin ( π / 4 ) / {σ}^{2} , & Q \geq 0 \\ 2 {Q}_{r} sin ( π / 4 ) / {σ}^{2} , & Q < 0\end{matrix} \\ = \sqrt{2} {Q}_{r} / {σ}^{2}\end{matrix} \qquad [ Equation 9 ]$$

According to the exemplary embodiment, it is possible to reduce an operation amount and enhance hardware complexity in comparison with the comparative example in which the maximum value of LLR is acquired by calculating all probabilities that the reference symbols will be positioned in each constellation diagram as shown in Equation 3. That is, by using the soft-decision type demapping algorithm according to the embodiment, it is possible to acquire the maximum value of LLR with an operation of small amount in the QPSK demodulation.

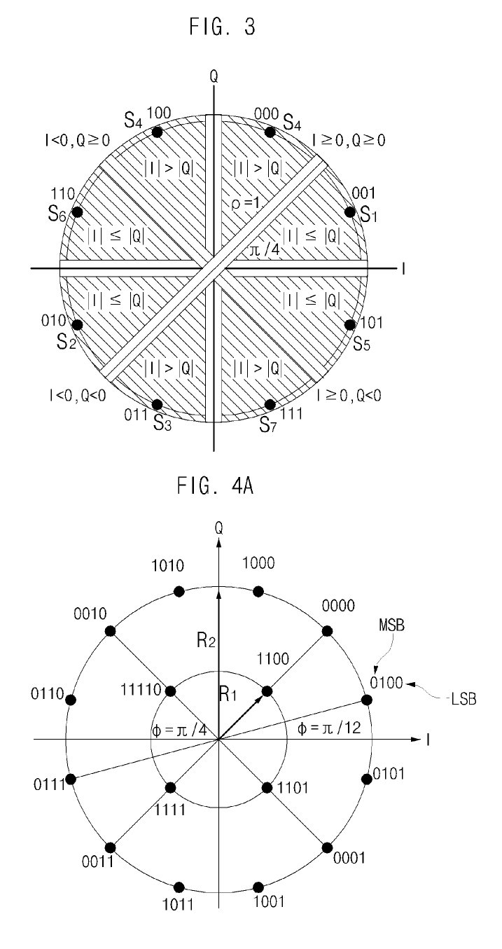

FIG. 3 is showing an 8-QPSK constellation diagram according to an exemplary embodiment of the present invention.

The soft-decision type demapping algorithm according to the embodiment calculates an LLR value by shifting a received symbol by a predetermined phase on an 8-PSK constellation diagram in the case of an 8-PSK modulation scheme.

That is, as shown in FIG. 3, when an I axis and a Q axis are screwed by π/4 and the received reference symbol is phase-shifted by −π/8, 8 signals of the 8-PSK constellation diagram may be partitioned into 4 sections like the QPSK constellation diagram.

In other words, the 8-PSK constellation diagram according to the embodiment is partitioned into 8 sections and the sections are disposed so that the MSBs of the in-phase and the quad-phase, that is, the sign bits are compared with absolute values of the in-phase and the quad-phase. Accordingly, only by comparing the sign bits with the absolute values of the in-phase and the quad-phase, the soft-decision type demapping operation can be performed.

For example, by using Equation 4 and Equation 8, LLR(b2) of the 8-PSK is calculated as shown in Equation 10.

$$LLR ( {b}_{2} ) = \{ \begin{matrix}- 1 / {σ}^{2} \{ {I}_{r} ( {I}_{{s}_{5}} - {I}_{{s}_{1}} ) + {I}_{r} ( {I}_{{s}_{5}} - {I}_{{s}_{1}} ) \} , & I \geq 0 , \vert I \vert \geq \vert Q \vert \\ - 1 / {σ}^{2} \{ {I}_{r} ( {I}_{{s}_{6}} - {I}_{{s}_{2}} ) + {I}_{r} ( {I}_{{s}_{6}} - {I}_{{s}_{2}} ) \} , & I < 0 , \vert I \vert \geq \vert Q \vert \\ - 1 / {σ}^{2} \{ {I}_{r} ( {I}_{{s}_{4}} - {I}_{{s}_{0}} ) + {I}_{r} ( {I}_{{s}_{4}} - {I}_{{s}_{0}} ) \} , & Q \geq 0 , \vert I \vert < \vert Q \vert \\ - 1 / {σ}^{2} \{ {I}_{r} ( {I}_{{s}_{7}} - {I}_{{s}_{3}} ) + {I}_{r} ( {I}_{{s}_{7}} - {I}_{{s}_{3}} ) \} , & Q < 0 , \vert I \vert < \vert Q \vert\end{matrix} \qquad [ Equation 10 ]$$

Where Iᵣ represents a reference value before phase shifting and Iₛᵢ (however, i is natural numbers of 0 to 8) represents a value of I at a position of si (however, i is natural numbers of 0 to 8) (see the constellation diagram of FIG. 3) after phase shifting.

By considering the 8-PSK constellation diagram defined in the standard, Equation 10 can be expressed as shown in Equation 11.

LLR(b₂)=K₁Iᵣ/σ²+K₂Qᵣ/σ² [Equation 11]

In Equation 11, LLR(b₀) and LLR(b₁) can be easily computed by differentiating values of K₁ and K₂. In Equation 11, when the value of K₁ is calculated, K₂ can be calculated by substituting I with Q. The values of K₁ and K₂ can be expressed, for example, as shown in Equation 12.

$$( {K}_{1} , {K}_{2} ) = \{ \begin{matrix}( 0.707 , - 0.293 ) , & I \geq 0 , Q \geq 0 \\ ( - 0.293 , - 0.707 ) , & I < 0 , Q \geq 0 \\ ( - 0.707 , 0.293 ) , & I < 0 , Q < 0 \\ ( 0.293 , 0.707 ) , & I \geq 0 , Q < 0\end{matrix} \qquad [ Equation 12 ]$$

As such, according to the embodiment, LLR(b₂) is calculated as shown in the last line of Equation 9 and thereafter, the rest LLR(b₀) and LLR(b₁) are calculated by changing the values of constants K₁ and K₂, such that it is possible to decrease the operation amount by omitting the exponential and logarithmic operations or the square root and squaring operation and to enhance hardware complexity.

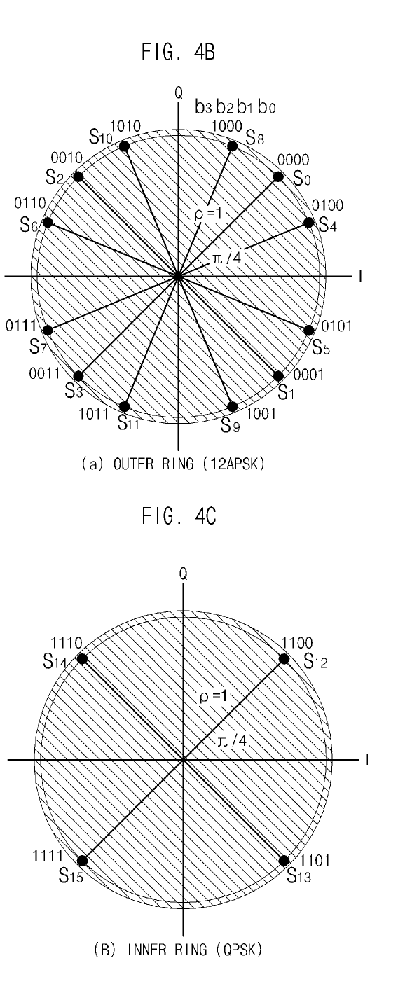

FIG. 4A is showing a 16-APSK constellation diagram for describing a soft-decision type demapping algorithm according to an exemplary embodiment of the present invention. FIG. 4B is showing an outer ring of 16-APSK constellation diagram of FIG. 4A and FIG. 4C is showing an inner ring of 16-APSK constellation diagram of FIG. 4A.

Referring to FIGS. 4A to 4C, the 16-APSK constellation diagram is constituted by two different signal levels, that is, an inner ring having a radius of R₁ and constituted by 4 constellations, and an outer ring having a radius of R₂ and constituted by 12 constellations unlike the QPSK and the 8-PSK. In addition, in the 16-APSK, no symbol are positioned on the I axis and the Q axis like the QPSK. Accordingly, in the embodiment, in the case of the 16-APSK, the constellation diagram is partitioned into the inner ring and the outer ring and the soft-decision type demapping is performed depending on the sizes of the radii of the two rings. That is, an LLR(b₃) value of the 16-APSK can be computed by applying the above-mentioned soft-decision type demapping algorithm of the 8-PSK and the QPSK at the outer ring shown in FIG. 4B and the inner ring shown in FIG. 4C, respectively.

LLR(b₃) computed by the soft-decision type demapping algorithm of the embodiment can be expressed as shown in Equation 13.

$$LLR ( {b}_{3} ) = log \frac{{e}^{{P}_{i {1}_{max}}} + {e}^{{P}_{o {1}_{max}}}}{{e}^{{P}_{i {2}_{max}}} + {e}^{{P}_{o {2}_{max}}}} \qquad [ Equation 13 ]$$

Where Pᵢ₁ₘₐₓ represents the maximum value of the probability density function (PDF) of the inner ring when b₃ is 0, Pₒ₁ₘₐₓ represents the maximum value of the PDF of the outer ring when b₃ is 0, Pₒ₂ₘₐₓ represents the maximum value of the PDF of the outer ring when b₃ is 1, and Pᵢ₂ₘₐₓ represents the maximum value of the PDF of the inner ring when b₃ is 1.

By using the MAX scheme, Equation 13 can be expressed as shown in Equation 14.

$$\begin{matrix}LLR ( {b}_{3} ) = max ( {P}_{i {1}_{max}} , {P}_{o {1}_{max}} ) - max ( {P}_{i {2}_{max}} , {P}_{o {2}_{max}} ) \\ = max ( \vert {I}_{r} - {I}_{{S}_{i 1}} \vert + \vert {Q}_{r} - {Q}_{{S}_{i 1}} \vert , \\ \vert {I}_{r} - {I}_{{S}_{o 1}} \vert + \vert {Q}_{r} - {Q}_{{S}_{o 1}} \vert - max \\ ( \vert {I}_{r} - {I}_{{S}_{i 2}} \vert + \vert {Q}_{r} - {Q}_{{S}_{i 2}} \vert , \\ \vert {I}_{r} - {I}_{{S}_{i 3}} \vert + \vert {Q}_{r} - {Q}_{{S}_{o 2}} \vert\end{matrix} \qquad [ Equation 14 ]$$

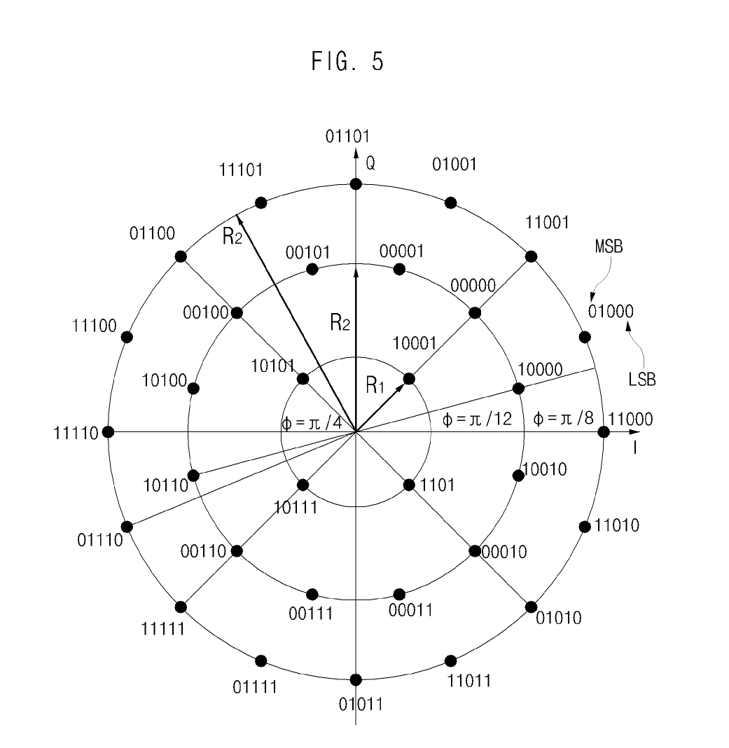

As another embodiment, as shown in FIG. 5, in 32-APSK modulation which is constituted by 3 rings, an LLR value may be also computed by applying the soft-decision type demapping algorithm in the same manner as the soft-decision type demapping algorithm used in 16-APSK. In 32-APSK modulation, a symbol is positioned on the I axis and the Q axis in the outermost ring. So, the LLR may be operated in the same manner as the LLR operation scheme of the 16-APSK after rotating and phase-shifting only the outermost ring by π/16 like the case of 8-PSK.

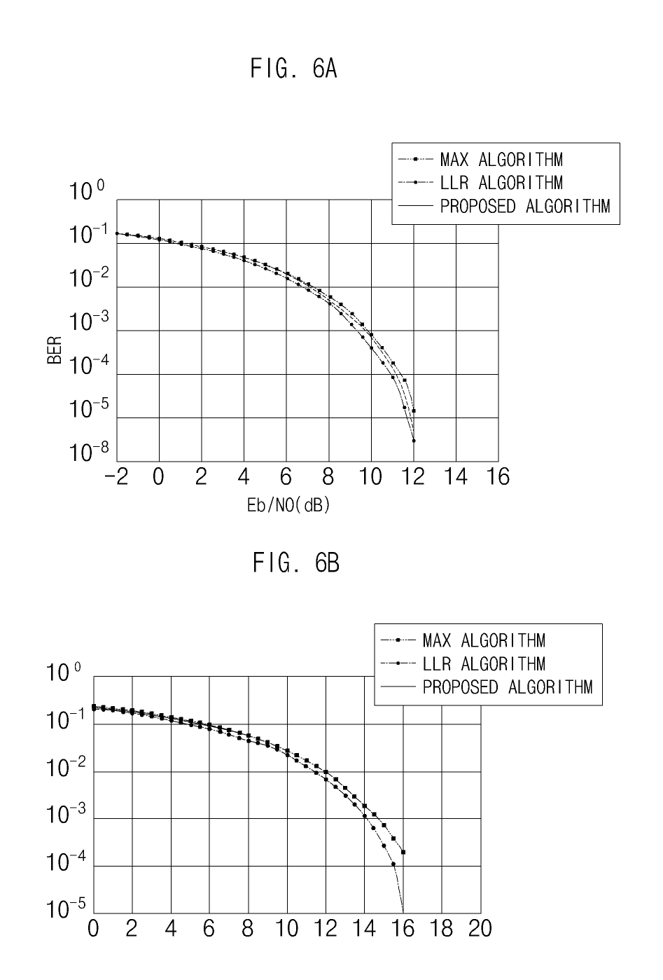

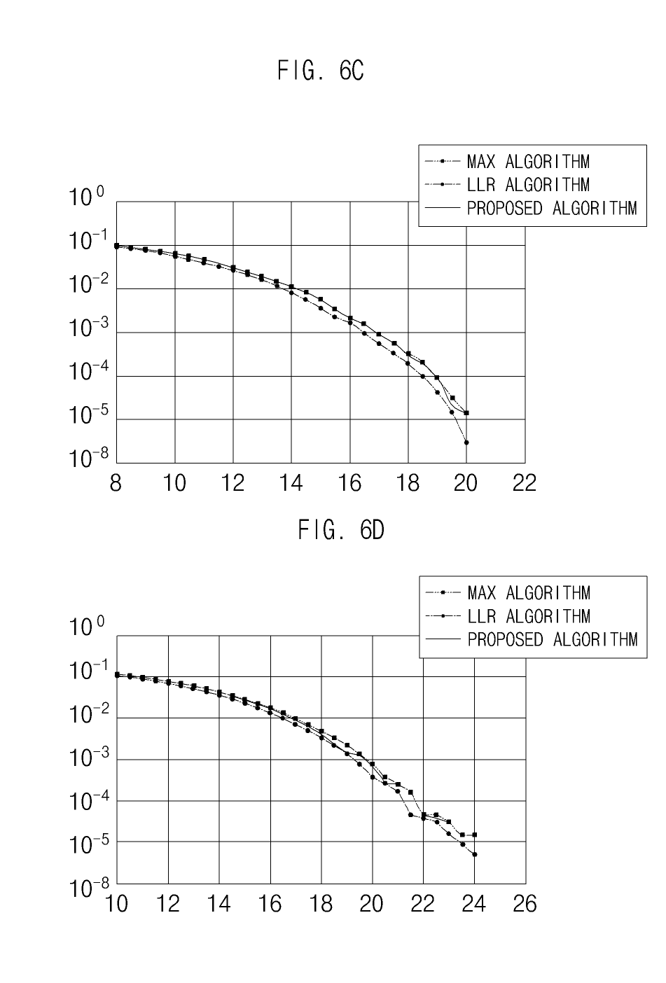

FIGS. 6A to 6D are diagrams comparing bit error ratio performance of an exemplary embodiment of the present invention with a related art scheme.

As shown in FIG. 6A, a proposed algorithm according the exemplary embodiment of the present invention shows substantially the same bit error ratio (BER) performance as the MAX scheme (MAX algorithm) of the comparative example or the LLR (LLR algorithm) of the comparative example in the case of SNR (Eb/N0) is in the range of approximately −2 dB to 12 dB in QPSK demodulation.

As shown in FIG. 6B, the proposed algorithm shows substantially the same bit error rate (BER) performance as the MAX algorithm of the comparative example or the LLR algorithm of the comparative example in the case in which SNR (Eb/N0) is in the range of approximately 0 dB to 16 dB in 8-PSK demodulation.

As shown in FIG. 6C, the proposed algorithm shows substantially the same bit error rate (BER) performance as the MAX algorithm of the comparative example or the LLR algorithm of the comparative example in the case in which SNR (Eb/N0) is in the range of approximately 8 dB to 20 dB in 16-APSK demodulation.

As shown in FIG. 6D, the proposed algorithm shows substantially the same bit error rate (BER) performance as the MAX algorithm of the comparative example or the LLR algorithm of the comparative example in the case in which SNR (Eb/N0) is in the range of approximately 10 dB to 24 dB in 32-APSK demodulation.

According to the exemplary embodiment, the proposed algorithm can be easily implemented without deteriorating the performance of the modulation schemes in comparison with the related art schemes. That is, according to the embodiment, it is possible to enhance hardware complexity while showing the same error detection performance in demodulation of a digital communication signal.

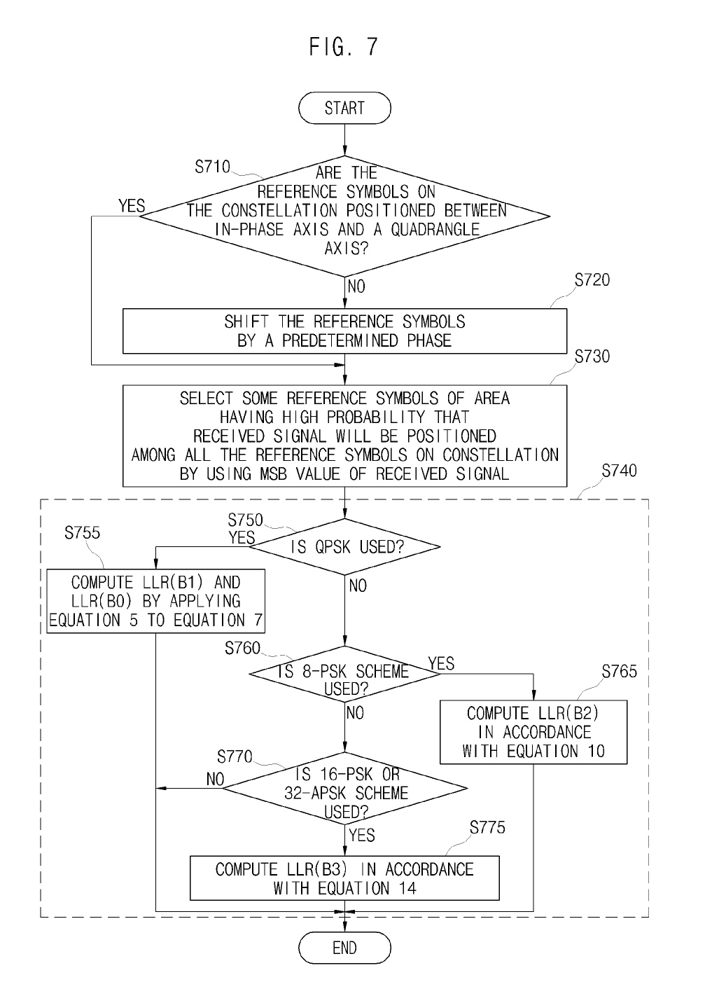

FIG. 7 is a flowchart of a soft-decision demapping method according to an exemplary embodiment of the present invention.

Procedures of the soft-decision demapping method being performed by a unit described in the above-mentioned embodiments are shown in FIG. 7.

First, in a digital signal received through a transmission channel in a communication system using a phase shift keying (PSK) scheme, the unit judges whether or not all reference symbols are positioned between an in-phase axis and a quad-phase axis on a constellation diagram (S710).

According to the judgment result of step S710, when at least one of the reference symbols exist on the in-phase axis or the quad-phase axis, the unit shifts the reference symbols by a predetermined phase (S720).

According to the judgment result of step S710, when all the reference symbols are positioned between the in-phase axis and the quad-phase axis, step S720 may not be performed.

Next, the unit selects some reference symbols of an area having a high probability that a received signal will be positioned among all the reference symbols on the constellation diagram using an MSB value of the received signal (S730).

Next, the unit acquires the maximum value of LLR with respect to only some selected reference symbols (S740). As such, the maximum value of LLR is calculated with respect to only some reference symbols by previously selecting the area having the high probability that the received signal will be positioned therein by using the MBS value of the received signal. So, it is possible to decrease an operation amount for detecting an error of the received signal and to reduce hardware complexity.

At step S740, a method of acquiring the maximum value of LLR may be flexibly applied depending on modulation and demodulation schemes used in the communication system.

For example, when the communication system uses a QPSK scheme (S750), the unit or a component of a receiving device including the unit can calculate LLR(b₁) and LLR(b₀) by adopting Equation 7 and Equation 5 (S755).

Further, when the communication system uses an 8-PSK scheme (S760), the unit can compute LLR(b₂) according to Equation 10 (S765). At this time, the reference symbols of the received signal may be shifted by a phase of −π/8 (S710 and S720).

Further, when the communication system uses 16-APSK or 32-APSK scheme (S770), the unit can compute LLR(b₂) according to Equation 14 (S775).

Of course, it will be apparent that the soft-decision demapping method according to the embodiment can adopt the above-mentioned operation schemes according to the QPSK scheme, the 8-PSK scheme, the 16-APSK scheme, the 32-APSK scheme, or a combination scheme thereof.

According to an exemplary embodiment, a point positioned in a constellation diagram is previously selected using only phase information of a symbol to decrease a comparison operation amount and remove a maximum value operation. Accordingly, the present invention may achieve stable performance even in a channel environment of a very low signal-to-noise ratio (SNR) and enhance hardware complexity which is a problem of the prior art. Further, it is possible to reduce a manufacturing cost of a DVB-S2 receiving chip and reduce power consumption of a set-top box by using an operation circuit. Moreover, the present invention is applied to a communication standard supporting various modulation schemes such as DVB-S2 contribute to efficient utilizing hardware resources and efficient transmission of a digital signal.

An exemplary embodiment of the present invention is disclosed through a detailed description and drawings as described above. Herein, specific terms have been used, but are just used for the purpose of describing the present invention and are not used for defining the meaning or limiting the scope of the present invention, which is disclosed in the appended claims. Therefore, it will be appreciated to those skilled in the art that various modifications are made and other equivalent embodiments are available. Accordingly, the actual technical protection scope of the present invention must be determined by the spirit of the appended claims.

What is claimed is:

1. A soft-decision demapping method for a digital signal received through a transmission channel in a communication system using a phase shift keying (PSK) scheme, comprising:
selecting reference symbols in an area having a higher probability than a predetermined probability that the received signal will be positioned among all reference symbols on a constellation diagram using a most significant bit (MSB) value of the received signal; and
acquiring a maximum value of a log likelihood ratio (LLR) for the selected reference symbols.

2. The method according to claim 1, further comprising shifting the reference symbols by a predetermined phase so that the reference symbols are positioned between an in-phase axis and a quad-phase axis when at least one reference symbol is positioned on the in-phase axis or the quad-phase axis of the constellation diagram.

3. The method according to claim 1, wherein the communication system computes LLR(b₁) and LLR(b₀) by applying Equation 5 to Equation 7 at the time of using quadrature phase shift keying (QPSK) scheme:
$$\begin{matrix}\begin{matrix}LLR ( {b}_{1} ) = max ( {P}_{0} , {P}_{1} ) - max ( {P}_{2} , {P}_{3} ) \\ = \{ \begin{matrix}{P}_{0} - {P}_{2} , & Q \geq 0 \\ {P}_{1} - {P}_{3} , & Q < 0\end{matrix}\end{matrix} & [ Equation 7 ] \\ {P}_{i} = \frac{- {\vert r - {s}_{i} \vert}^{2}}{2 {σ}^{2}} , \\ i = 0 , … , 7 & [ Equation 5 ]\end{matrix}$$
Where Pᵢ represents a probability density function of the reference symbol received through a white noise channel, r represents a radius of the constellation diagram, Sᵢ represents a constellation point on the constellation diagram, and σ² represents a dispersion level of white noise.

4. The method according to claim 1, wherein the communication system shifts the received reference symbol by a phase of −π/8 and computes LLR(b₂) in accordance with Equation 10 being acquired from Equations 2, 4, 5, and 8 at the time of using an 8-PSK scheme:
$${P}_{i} = \frac{1}{\sqrt{2 {πσ}^{2}}} {e}^{\frac{{\vert r - {s}_{i} \vert}^{2}}{2 {σ}^{2}}} , \\ i = 0 , … , 7 \qquad [ Equation 2 ]$$
Where Pᵢ represents the probability density function of the reference symbol received through the white noise channel, r represents a radius of the constellation diagram, Sᵢ represents the constellation point on the constellation diagram, and σ² represents the dispersion level of white noise.
LLR(b₂)={ max(P₀,P₁,P₂,P₃)−max(P₄,P₅,P₆,P₇)}
LLR(b₁)={ max(P₀,P₁,P₄,P₅)−max(P₂,P₃,P₆,P₇)}
LLR(b₀)={ max(P₀,P₂,P₄,P₆)−max(P₁,P₃,P₅,P₇)} [Equation 4]
Where Pᵢ (here, i includes 0 and natural numbers) becomes an exponential part in the probability density function of Equation 2 as shown in Equation 5,
$$\begin{matrix}{P}_{i} = \frac{- {\vert r - {s}_{i} \vert}^{2}}{2 {σ}^{2}} , \\ i = 0 , … , 7 & [ Equation 5 ] \\ \begin{matrix}LLR ( {b}_{1} ) = \{ \begin{matrix}- 1 / {σ}^{2} \{ {I}_{r} ( {I}_{{s}_{2}} - {I}_{{s}_{0}} ) + {Q}_{r} ( {Q}_{{s}_{2}} - {Q}_{{s}_{0}} ) \} , & Q \geq 0 \\ - 1 / {σ}^{2} \{ {I}_{r} ( {I}_{{s}_{3}} - {I}_{{s}_{1}} ) + {Q}_{r} ( {Q}_{{s}_{3}} - {Q}_{{s}_{1}} ) \} , & Q < 0\end{matrix} \\ = \{ \begin{matrix}- 1 / {σ}^{2} \{ {I}_{r} ( cos ( 3 π / 4 ) - cos ( π / 4 ) ) + {Q}_{r} ( sin ( 3 π / 4 ) - sin ( π / 4 ) ) \} , & Q \geq 0 \\ - 1 / {σ}^{2} \{ {I}_{r} ( cos ( - 3 π / 4 ) - cos ( - π / 4 ) ) + {Q}_{r} ( sin ( - 3 π / 4 ) - sin ( - π / 4 ) ) \} , & Q < 0\end{matrix} \\ = \{ \begin{matrix}2 {I}_{r} cos ( π / 4 ) / {σ}^{2} , & Q \geq 0 \\ 2 {I}_{r} cos ( π / 4 ) / {σ}^{2} , & Q < 0\end{matrix} \\ = \sqrt{2} {I}_{r} / {σ}^{2}\end{matrix} & [ Equation 8 ]\end{matrix}$$
Where I_{y} represents an in-phase value of the received reference symbol and Q_{y} represents a quad-phase value of the received reference symbol,
$$LLR ( {b}_{2} ) = \{ \begin{matrix}- 1 / {σ}^{2} \{ {I}_{r} ( {I}_{{s}_{5}} - {I}_{{s}_{1}} ) + {I}_{r} ( {I}_{{s}_{5}} - {I}_{{s}_{1}} ) \} , & I \geq 0 , \vert I \vert \geq \vert Q \vert \\ - 1 / {σ}^{2} \{ {I}_{r} ( {I}_{{s}_{6}} - {I}_{{s}_{2}} ) + {I}_{r} ( {I}_{{s}_{6}} - {I}_{{s}_{2}} ) \} , & I < 0 , \vert I \vert \geq \vert Q \vert \\ - 1 / {σ}^{2} \{ {I}_{r} ( {I}_{{s}_{4}} - {I}_{{s}_{0}} ) + {I}_{r} ( {I}_{{s}_{4}} - {I}_{{s}_{0}} ) \} , & Q \geq 0 , \vert I \vert < \vert Q \vert \\ - 1 / {σ}^{2} \{ {I}_{r} ( {I}_{{s}_{7}} - {I}_{{s}_{3}} ) + {I}_{r} ( {I}_{{s}_{7}} - {I}_{{s}_{3}} ) \} , & Q < 0 , \vert I \vert < \vert Q \vert\end{matrix} \qquad [ Equation 10 ]$$
Where Iᵣ represents a reference symbol value before phase shifting and Iₛᵢ (however, i is natural numbers of 0 to 8) represents a reference symbol value at a position of sᵢ (however, i is natural numbers of 0 to 8) after phase shifting.

5. The method according to claim 4, wherein LLR(b₀) and LLR(b₁) are computed in accordance with Equation 11 acquired from Equation 10:
LLR(b₂)=K₁Iᵣ/σ²+K₂Qᵣ/σ² [Equation 11]
Where values of K₁ and K₂ are different from each other and when the value K₁ is calculated, K₂ is calculated by converting I to Q and the values of K₁ and K₂ as are shown in FIG. 12.
$$( {K}_{1} , {K}_{2} ) = \{ \begin{matrix}( 0.707 , - 0.293 ) , & I \geq 0 , Q \geq 0 \\ ( - 0.293 , - 0.707 ) & I < 0 , Q \geq 0 \\ ( - 0.707 , 0.293 ) , & I < 0 , Q < 0 \\ ( 0.293 , 0.707 ) , & I \geq 0 , Q < 0.\end{matrix} \qquad [ Equation 12 ]$$

6. The method according to claim 1, wherein the communication system computes LLR(b₃) in accordance with Equation 14 at the time of using 16-APSK scheme:
$$\begin{matrix}LLR ( {b}_{3} ) = max ( {P}_{i {1}_{max}} , {P}_{o {1}_{max}} ) - max ( {P}_{i {2}_{max}} , {P}_{0 {2}_{max}} ) \\ = max ( \vert {I}_{r} - {I}_{{S}_{i 1}} \vert + \vert {Q}_{r} - {Q}_{{S}_{i 1}} \vert , \vert {I}_{r} - {I}_{{S}_{o 1}} \vert + \\ \vert {Q}_{r} - {Q}_{{S}_{o 1}} \vert - \\ max ( \vert {I}_{r} - {I}_{{S}_{i 2}} \vert + \vert {Q}_{r} - {Q}_{{S}_{i 2}} \vert , \vert {I}_{r} - {I}_{{S}_{i 3}} \vert + \\ \vert {Q}_{r} - {Q}_{{S}_{o 2}} \vert\end{matrix} \qquad [ Equation 14 ]$$
Where Pᵢ₁ₘₐₓ represents the maximum value of the probability density function of an inner ring when b₃ is 0, Pₒ₁ₘₐₓ represents the maximum value of the probability density function of an outer ring when b₃ is 0, Pₒ₂ₘₐₓ represents the maximum value of the probability density function of the outer ring when b₃ is 1, and Pᵢ₂ₘₐₓ represents the maximum value of the probability density function of the inner ring when b₃ is 1.

7. The method according to claim 6, wherein the communication system computes LLR(b₃) in accordance with Equation 14 at the time of using a 32 APSK constituted by three rings.
